(19) United States
(12) Patent Application Publication
(10) Pub. No.: US 2026/0048366 A1
(43) Pub. Date: Feb. 19, 2026

(54) DEVICE AND AGITATOR SYSTEM FOR THE MECHANICAL ACTIVATION OF ORGANIC AND/OR INORGANIC SUBSTANCES AND/OR SUBSTANCE MIXTURES IN CHEMICAL, PHARMACEUTICAL, FOOD-RELATED AND/OR BUILDING MATERIAL-RELATED APPLICATIONS

(71) Applicant: NETZSCH Trockenmahltechnik GmbH, Selb (DE)

(72) Inventors: Ann-Christin Brandt, Kahl am Main (DE); Claus Simon, Alzenau (DE); Mario Wührl, Selb (DE)

(21) Appl. No.: 19/298,525

(22) Filed: Aug. 13, 2025

(30) Foreign Application Priority Data
Aug. 14, 2024 (DE) 102024123299.4

(51) Int. Cl. B01F 27/1151; B01F 27/07; B01J 19/00

(52) U.S. Cl. CPC B01F 27/1151; B01F 27/071; B01J 19/0066

(57) ABSTRACT

A device for mechanical activation of organic and/or inorganic substances and/or substance mixtures in chemical, pharmaceutical, food-related and/or building material-related applications includes a disk-like agitating body for rotationally fixed mounting on an agitator shaft, and at least one impact unit, which has a head region with an activation surface for cooperation with activation bodies, wherein the at least one impact unit is fastened to the disk-like agitating body radially on the outside with respect to an axis of rotation of the disk-like agitating body. An agitator system with the device is also disclosed.

### TECHNICAL FIELD

The disclosure herein relates to a device for the mechanical activation of organic and/or inorganic substances and/or substance mixtures in chemical, pharmaceutical, food-related and/or building material-related applications as well as an agitator system with a device of this type.

### BACKGROUND

The point of mechanochemistry is that material is brought into an active state, in which the material is particularly reactive, by a mechanical activation, in particular by shear and normal strains. Mechanochemistry is thus understood to be the mechanical activation of chemical reactions. This can be attributed, for example, to a destabilization of the atomic bond and changes to the crystal structures. The reactions are additionally promoted by the comminution of the particles and the creation of new reactive surfaces. In contrast to previous reactions, the mechanochemistry can manage without any solvents or any thermal treatment, which can have a negative impact on the environment.

Until now, vibratory mills and planetary ball mills as well as extrusion processes have been used in the prior art for this purpose. The machines used thereby are characterized by an insufficient degree of activation as well as the scaling, which is only partly possible, to a production-related scale. Until now, an adaptation or setting, respectively, of the geometric and process-related activation parameters to the substances or substance mixtures to be activated, has likewise only be limited.

A majority of the reactions, which run in ball mills, are assigned to catalytic processes. Here, known reactions are, for example, C—N or C—C cross-coupling, cyclo-additivation, polymer reactions or C—H activation. It is a known disadvantage of catalytic processes that the recovery of the catalyst is difficult to accomplish for the most part.

### SUMMARY

It is the object of the disclosure herein to provide a device and an agitator system for chemical, pharmaceutical, food-related and/or building material-related applications, which can be embodied without solvents and which can be scaled to a sufficient production-related scale.

According to the disclosure herein, this object is in each case solved by the subject matter herein.

According to a first aspect of the disclosure herein, a device for the mechanical activation of organic and/or inorganic substances and/or substance mixtures in chemical, pharmaceutical, food-related and/or building material-related applications is provided. The device comprises a disk-like agitating body for the rotationally fixed mounting on an agitator shaft. The device further comprises at least one impact unit, which has a head region with an activation surface for cooperation with activation bodies. The at least one impact unit is fastened to the disk-like agitating body radially on the outside with respect to an axis of rotation of the disk-like agitating body.

According to a second aspect of the disclosure herein, an agitator system for the mechanical activation of organic and/or inorganic substances and/or substance mixtures in chemical, pharmaceutical, food-related and/or building material-related applications is provided. The agitator system comprises a container for receiving activation bodies as well as a substance and/or substance mixture to be activated. The agitator system further comprises an agitator shaft, which is mounted in the container and so as to be rotatable with respect to the container. The agitator system furthermore comprises at least one device according to the first aspect of the disclosure herein, wherein the disk-like agitating body is mounted in a rotationally fixed manner on the agitator shaft.

An idea on which the disclosure herein is based is to effect a mechanical activation of the substances and/or substance mixtures introduced into the agitator system or into the container, respectively, by the device, in particular to accelerate carrying out mechanochemical reactions in the agitator system or to make them possible in the first place. The activation bodies located in the interior of the container are set into the motion, which is desired for the activation reaction, by the rotational movement of the at least one impact unit or of the impact units, respectively.

The at least one impact unit can in particular protrude radially or in the radial direction, respectively, from the disk-like agitating body with respect to the axis of rotation of the disk-like agitating body.

In terms of the disclosure herein, the mechanical activation of organic and/or inorganic substances and/or substance mixtures in chemical, pharmaceutical, food-related and/or building material-related applications refers to the effect of mechanical stresses on the substance and/or the substance mixture, so that chemical reactions, in particular reactions relating to polymers, are set in motion or are activated, respectively. For example, mechanical stresses of this type can lead to the depolymerization of polymers. In particular, no solvents or the like are used during the mechanical activation. This means that the mechanical activation for the mechanochemical effect is carried out in a dry container.

It is an advantage of the disclosure herein that no byproducts are created. It is a further advantage that significantly less energy is required due to the device according to the disclosure herein and/or that the reaction of the substance and/or substance mixture can run in a greatly accelerated manner.

A degree of activation can furthermore be increased and a scaling and adaptability for different applications can be improved.

Advantageous embodiments and further developments result from the description with reference to the figures.

According to an embodiment of the disclosure herein, the at least one impact unit has a plurality of impact units, which are arranged so as to be distributed evenly in a circumferential direction of the disk-like agitating body. The substance and/or the substance mixture to be activated can be activated essentially evenly by the plurality of impact units in this way when the disk-like agitating body rotates.

According to a further embodiment of the disclosure herein, the plurality of impact units is selected as a function of an angle between two adjacent impact units, of a diameter of the disk-like agitating body, of a rotational speed of the disk-like agitating body and of a diameter of the activation bodies. The number of the impact units can thus be selected as needed at the disk-like agitating body. The angle between two adjacent impact units can be, for example, approximately 10° to approximately 180°, in particular approximately 10° to approximately 120°.

For example, the at least one impact unit can have a length in the range of approximately 10 mm to approximately 120 mm. The head region of the at least one impact unit can in particular have a length in the range of approximately 10 mm to approximately 120 mm.

According to a further embodiment of the disclosure herein, the disk-like agitating body has at least one passage opening, which extends in the direction of the axis of rotation. A size of the at least one passage opening can furthermore be variable, so that a permeability of the disk-like agitating body can be varied. An air quantity, which flows through, and a substance and/or substance mixture to be activated can be forced in this way to flow around the disk-like agitating body.

According to a further embodiment of the disclosure herein, the at least one passage opening has a plurality of passage openings, which are arranged so as to be distributed evenly in a circumferential direction of the disk-like agitating body. The substance and/or the substance mixture can thus pass or flow through, respectively, the disk-like agitating body, without coming into contact with the at least one impact unit.

According to a further embodiment of the disclosure herein, the activation surface is aligned in an angular range of approximately 0° to approximately 45° with respect to the axis of rotation. The activation surface can thus improve shear forces and can thus effect a higher activation with lower energy consumption. In an example manner, the activation surface is formed, for example, in an essentially flat manner.

According to a further embodiment of the disclosure herein, the head region is connected to the impact unit in an exchangeable manner. The head region can be changed as needed in this way, for example when the activation surface is worn out or when, for example, a different size and/or shape of the activation surface is provided for the substance and/or substance mixture to be activated. The head region can thus be formed in a modular manner. Advantageously, a surface load of the activation surface can thus be improved or a width of the head region can be changed as a function of a hardness of the substance and/or substance mixture to be activated.

According to a further embodiment of the disclosure herein, the head region has an essentially cube-like shape.

According to a further embodiment of the disclosure herein, the at least one impact unit has an extension arm, which is arranged between the disk-like agitating body and the activation surface. A first end region of the extension arm can thereby be fastened to the disk-like agitating body and a second end region facing away from the first end region can be coupled to the activation surface.

According to an embodiment of the agitator system of the disclosure herein, a radially outer end of the at least one impact unit has a distance from the container in the range of twice to ten times a diameter of the activation bodies. The activation bodies can flow past the at least one impact unit in this way, wherein a desired activation effect can be ensured by the at least one impact unit.

According to a further embodiment of the disclosure herein, the at least one device has a plurality of devices, which are arranged in series on the agitator shaft. For example, the plurality or number, respectively, of devices can be 4 to 20, in particular 7 to 15. Alternatively or additionally, the plurality or number, respectively, of devices can be a function of the diameter of the activation bodies and of a ratio of length to diameter of the container.

According to a further embodiment of the disclosure herein, the at least one impact unit of adjacent devices of the plurality of devices are in each case arranged on the agitator shaft with an offset of 5° to 90° from one another. The activation surfaces can thus be increased and/or the distances between the adjacent devices can be decreased, without the impact units of the adjacent devices colliding with one another. Alternatively, the at least one impact unit of adjacent devices of the plurality of devices can in each case be arranged on the agitator shaft so as to be aligned with one another.

A distance between two devices can be, for example, between 10 times and 30 times or between 4 and 100 times a diameter of the activation bodies. The distance between two head regions can in particular be dimensioned by impact units, which are arranged so as to be aligned with one another.

According to a further embodiment of the disclosure herein, the container has a plurality of activation zones, which differ from one another and which are arranged successively along a flow-through direction of the substance and/or substance mixture to be activated. A number, a type and/or a design of the plurality of activation zones. which differ from one another, can be selected thereby as a function of the substance and/or substance mixture to be activated.

The flow-through direction corresponds, for example, to the axis of rotation of the disk-like agitating body or the agitator shaft, respectively. The container can have a ratio of length to diameter in a range of approximately 2 to approximately 5. The container is preferably formed cylindrically. The axis of rotation of the agitator shaft can be aligned, for example, essentially horizontally in the container. The agitator shaft can in particular be attached centrically in the container in a rotatable manner.

The container can furthermore be stationary with respect to a surrounding area. The container can optionally have a coating on its inner side. The coating can contain a reactive material, for example palladium. The mechanochemical reaction effect in the container can be improved or made possible in the first place by the coating.

According to a further embodiment of the disclosure herein, the plurality of activation zones, which differ from one another, comprises at least one activation zone selected from the group of an inlet zone for the improved intake of the substance and/or substance mixture to be activated, a comminution zone for providing a particle size distribution suitable for the activation, an activation zone for the creation of a largest possible activation, a relaxation zone and a discharge zone for retaining the activation bodies and avoiding reaction processes of the activated substance and/or substance mixture. For example, the above-mentioned activation zones are arranged in the mentioned order along the flow-through direction. The plurality of activation zones, which differ from one another, can comprise, for example, the inlet zone, the comminution zone, the activation zone and the discharge zone. The relaxation zone can optionally be supplemented thereby.

The inlet zone can thereby have at least one inlet tool, wherein the inlet tool is in particular formed as intake auger, as pre-crushing element or the like. The at least one inlet tool can combine several inlet tools of the same type or of a different type. The comminution zone or pre-activation zone, respectively, can in particular be formed to achieve a particle size distribution, which is suitable for the activation, wherein a generation or avoidance of superfines is provided, depending on the type of the substance and/or substance mixture to be activated. The activation zone can furthermore be formed to achieve a largest possible activation via a control of a dwell time in the activation zone and a strain type and strain intensity in the activation zone. The discharge zone or outlet zone, respectively, can have a separating system for retaining the activation bodies and avoidance of reaction processes of the activated substance and/or substance mixture.

On the basis of a predetermined combination of different structural activation parameters and of different process-related activation parameters, the substance and/or the substance mixture to be activated can be guided through the activation zones. An optimal mechanochemical reaction process can thus be provided. The structural activation parameters comprise, for example, different geometric embodiments of the disk-like agitating body, of the extension arm and/or of the head region of the impact unit. The process-related activation parameters comprise, for example, a circumferential speed, a fill level of the activation bodies, a temperature in the container and/or flow-through of the container with a process gas, which is required for the mechanochemical reaction.

According to a further embodiment of the disclosure herein, the activation bodies are formed essentially spherically, wherein a sphere-equivalent diameter of the activation bodies lies in the range of approximately 1 mm to approximately 15 mm. The activation bodies can be made of steel, ceramic, plastic, composite material, reactive material, such as, for example, palladium, and/or a material combination thereof. The activation bodies can furthermore be coated with one of the above-mentioned materials or a material combination thereof.

According to a further embodiment of the disclosure herein, the container has a double jacket for the insulation of its interior space with respect to a surrounding area. Alternatively or additionally, the agitator system can have a temperature-control unit for heating or cooling the container. The temperature-control unit can be thermally coupled to the container thereby. The container or its interior space, respectively, can be heated, cooled or heated as well as cooled in this way according to the temperature required for an activation reaction.

A movement of the activation bodies, which leads to an impact strain and/or a shear strain, can furthermore be capable of being set as a function of the activation reaction.

According to a further embodiment of the disclosure herein, the agitator shaft is motor-driven. For example, the agitator shaft can be driven by a motor arranged outside the container, wherein the motor is formed and operated to be variable in speed.

According to a further embodiment of the disclosure herein, the agitator system has an inlet opening and an outlet opening, wherein the inlet opening and the outlet opening are arranged on opposite sides of the container. For example, the pre-crushing element can be arranged, in particular attached, in the region of the inlet opening. Alternatively or additionally, the outlet opening can be arranged at the discharge zone. The separating system can be installed into the outlet opening thereby.

To support or improve the activation reaction, a reaction gas, a fluid or a solid can be added into the container via an additional opening of the container.

According to a further embodiment of the disclosure herein, the agitator system further comprises a spacer sleeve, which is mounted between adjacent devices on the agitator shaft. The spacer sleeve can thereby have, for example, a passage opening, which corresponds to the passage opening of the disk-like agitating body, so that the passage opening of the spacer sleeve and the passage opening of the disk-like agitating body can form a common passage opening. In other words, the passage opening of the spacer sleeve and the passage opening of the disk-like agitating body can be arranged so as to be aligned. An air guidance and thus a control of a flow direction and of a flow speed can thus be influenced. The spacer sleeve can vary in diameter and in shape. The spacer sleeve serves in particular for a targeted guidance of the air and of the substance and/or substance mixture to be activated through the container.

For example, the agitator shaft can be formed in one piece or in multiple pieces. Alternatively or additionally, the agitator shaft can be formed as massive shaft or as hollow shaft.

Where this makes sense, the above embodiments and further developments can be combined as desired. In particular, all features of the device are transferable to the corresponding method, and vice versa. Further possible embodiments, further developments and implementations of the disclosure herein also comprise combinations, which are not mentioned explicitly, of features of the disclosure herein, which have been described above or which will be described below with regard to the example embodiments. The person of skill in the art will thereby in particular also add individual aspects as improvements or additions to the respective basic form of the disclosure herein.

### BRIEF DESCRIPTION OF THE DRAWINGS

The disclosure herein will be explained in more detail below on the basis of example embodiments with reference to the enclosed figures of the drawings, in which:

FIG. 1 shows a schematic sectional view of an agitator system for the mechanical activation of organic and/or inorganic substances and/or substance mixtures in chemical, pharmaceutical, food-related and/or building material-related applications according to an example embodiment of the disclosure herein;

FIG. 2 shows a schematic detail view of a cutout of an agitator shaft of an agitator system according to a further example embodiment of the disclosure herein with a plurality of impact units, which are arranged offset from one another;

FIG. 3 shows a schematic side view of a device for the mechanical activation of organic and/or inorganic substances and/or substance mixtures in chemical, pharmaceutical, food-related and/or building material-related applications according to a further example embodiment of the disclosure herein (closed embodiment);

FIG. 4 shows a schematic side view of the device from FIG. 3 according to a further example embodiment of the disclosure herein with a plurality of passage openings in the agitating body (partially open embodiment); and

FIG. 5 shows a schematic side view of the device from FIGS. 3 and 4 according to a further example embodiment of the disclosure herein with a plurality of passage openings in the agitating body (open embodiment).

### DETAILED DESCRIPTION

Unless stated otherwise, identical, functionally identical and identically acting elements, features and components are in each case provided with the same reference numerals in the figures of the drawing.

Even though specific embodiments and further developments are illustrated and described in the present case, the person of skill in the art will prefer that a plurality of alternative and/or similar embodiments can replace the illustrated and described specific example embodiments, without turning away from the scope of the disclosure herein. This application is to generally cover all modifications or changes of the specific example embodiments described herein.

The enclosed figures are to convey a further understanding of embodiments of the disclosure herein and, in connection with the description, serve the purpose of explaining principles and concepts of the disclosure herein. Other example embodiments and many of the mentioned advantages follow with regard to the drawings. The drawings are to only be understood as schematic drawings and the elements of the drawings are not necessarily illustrated to scale. Terminology specifying a direction, such as, for instance, “top”, “bottom”, “left”, “right”, “above”, “below”, “horizontal”, “vertical”, “front”, “rear” and similar details are used only for explanatory purposes and do not serve the purpose of limiting the generality to specific designs as shown in the figures.

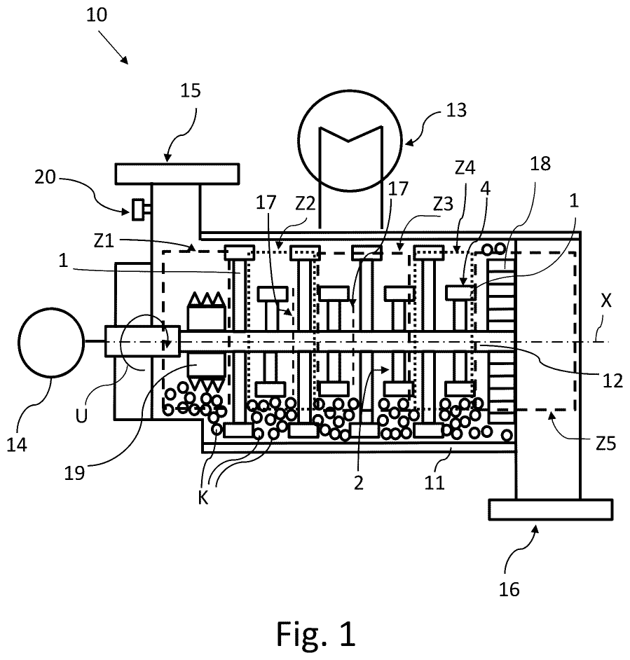

FIG. 1 shows a schematic sectional view of an agitator system 10 for the mechanical activation of organic and/or inorganic substances and/or substance mixtures in chemical, pharmaceutical, food-related and/or building material-related applications according to an example embodiment of the disclosure herein.

For example, the agitator system 10 comprises a container 11 for receiving activation bodies K as well as a substance and/or substance mixture to be activated, an agitator shaft 12, a temperature-control unit 13 for heating or cooling the container 11, a motor 14, an inlet opening 15, an outlet opening 16, two spacer sleeves 17, a separating system 18, a pre-crushing element 19 and an additional opening 20.

The agitator system 10 furthermore comprises a plurality of devices 1 for the mechanical activation of organic and/or inorganic substances and/or substance mixtures in chemical, pharmaceutical, food-related and/or building material-related applications. Each device 1 comprises a disk-like agitating body 2, which is mounted in a rotationally fixed manner on the agitator shaft 12, as well as a plurality of impact units 3. The plurality of impact units 3 in each case has a head region 4 with an activation surface 5 for cooperation with the activation bodies K. The plurality of impact units 3 is fastened to the disk-like agitating body 2 radially on the outside with respect to an axis of rotation X of the disk-like agitating body 2. With respect to the axis of rotation X of the disk-like agitating body 2, the plurality of impact units 3 can in particular protrude radially or in the radial direction, respectively, from the disk-like agitating body 2.

As illustrated in an example manner in FIG. 1, the plurality of devices 1 can be arranged in series on the agitator shaft 12. For example, the plurality or number, respectively, of devices can be 4 to 20, in particular 7 to 15, particularly preferably 8. Alternatively or additionally, the plurality or number, respectively, of devices 1 can be a function of the diameter of the activation bodies K and of a ratio of length to diameter of the container 11.

The impact units 3 of adjacent devices of the plurality of devices 1 can, for example, in each case be arranged on the agitator shaft 12 with an offset of 5° to 90° from one another. The activation surfaces 5 can thus be increased and/or the distances between the adjacent devices can be decreased, without the impact units 3 of the adjacent devices 1 colliding with one another. Alternatively, the impact units 3 of adjacent devices of the plurality of devices 1 can in each case be arranged on the agitator shaft 12 so as to be aligned with one another.

The agitator shaft 12 is mounted in the container 11 and rotatable with respect to the container 11. A radially outer end of the respective impact unit 3 can thereby have a distance from the container 11 in the range of twice to ten times a diameter of the activation bodies K. For example, the activation bodies K can be formed essentially spherically, as it is illustrated schematically in FIG. 1, wherein a sphere-equivalent diameter of the activation bodies K lies in the range of approximately 1 mm to approximately 15 mm. The activation bodies K can be made of steel, ceramic, plastic, composite material and/or reactive material, such as, for example, palladium. Alternatively or additionally, the activation bodies K can be made of a material combination of the above-mentioned materials. The activation bodies K can furthermore be coated with one of the above-mentioned materials or a material combination thereof.

The container 11 can optionally have a double jacket for the insulation of its interior space with respect to a surrounding area. The temperature-control unit 13 can be thermally coupled to the container 11. The container 11 or its interior space, respectively, can be heated, cooled or heated as well as cooled in this way according to the temperature required for an activation reaction.

A movement of the activation bodies K, which leads to an impact strain and/or a shear strain, can furthermore be capable of being set as a function of the activation reaction.

The motor 14 can be arranged, for example, outside the container 11 and can drive the agitator shaft 12 by a motor. The motor 14 can thereby be formed and operated to be variable in speed.

The inlet opening 15 and the outlet opening 16 can be arranged, for example, on opposite sides of the container 11. For example, the pre-crushing element 19 can be arranged, in particular attached, in the region of the inlet opening 15. Alternatively or additionally, the separating system 18 can be installed into the outlet opening 16.

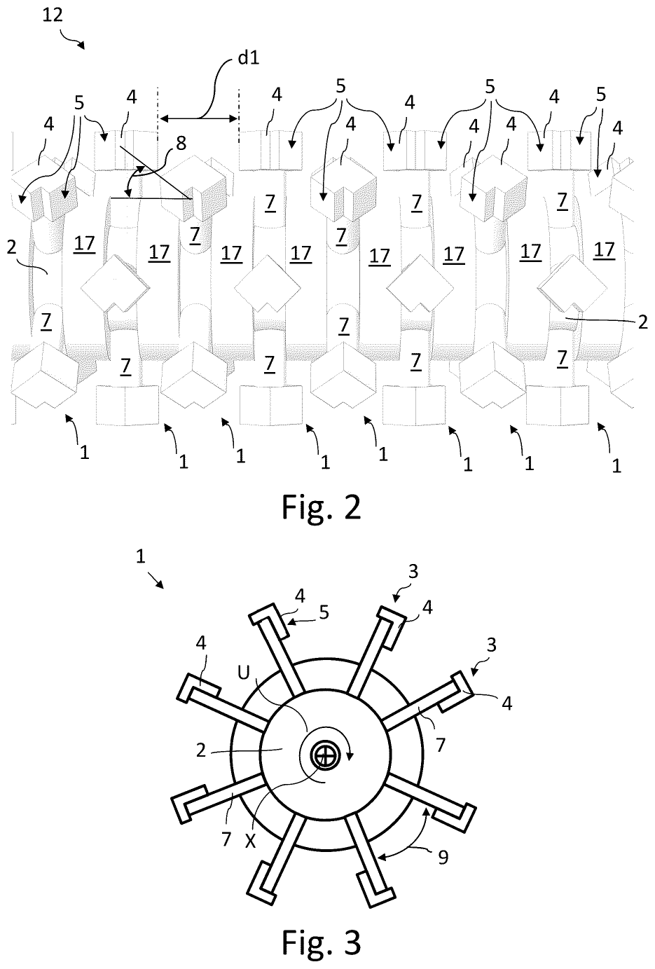

The spacer sleeve 17 can be mounted between adjacent devices 1 on the agitator shaft 12. The spacer sleeves 17 are illustrated schematically as dashed line in FIG. 1 and are subsequently illustrated and described more clearly in FIG. 2.

To support or improve the activation reaction, a reaction gas, a fluid or a solid can be added into the container 11 via the additional opening 20 of the container 11.

As illustrated in an example manner in FIG. 1 by dashed or dotted rectangles, respectively, the container 11 can have a plurality of activation zones Z1, Z2, Z3, Z4, Z5, which differ from one another and which are arranged successively along a flow-through direction of the substance and/or substance mixture to be activated. A number, a type and/or a design of the plurality of activation zones Z1, Z2, Z3, Z4, Z5, which differ from one another, can be selected thereby as a function of the substance and/or substance mixture to be activated. The flow-through direction corresponds, for example, to the axis of rotation X of the disk-like agitating body 2 or of the agitator shaft 12, respectively.

The container 11 can have a ratio of length to diameter in a range of approximately 2 to approximately 5. The container 11 is preferably formed cylindrically. The axis of rotation X of the agitator shaft 12 can be aligned, for example, essentially horizontally in the container 11. The agitator shaft 12 can in particular be attached centrically in the container 11 in a rotatable manner. The container 11 can furthermore be stationary with respect to a surrounding area. The container 11 can optionally have a coating on its inner side. The coating can contain a reactive material, for example palladium. The mechanochemical reaction effect in the container 11 can be improved or made possible in the first place by the coating.

For example, the plurality of activation zones Z1, Z2, Z3, Z4, Z5, which differ from one another, comprises an inlet zone Z1 for the improved intake of the substance and/or substance mixture to be activated, a comminution zone Z2 for providing a particle size distribution suitable for the activation, an activation zone Z3 for the creation of a largest possible activation, an optional relaxation zone Z4 and a discharge zone Z5 for retaining the activation bodies K and avoiding reaction processes of the activated substance and/or substance mixture. For example, the above-mentioned activation zones are arranged in the mentioned order along the flow-through direction.

The inlet zone can thereby have at least one inlet tool, wherein the inlet tool is in particular formed as intake auger, as pre-crushing element 19 or the like. The at least one inlet tool can combine several inlet tools of the same type or of a different type. The comminution zone or pre-activation zone Z2, respectively, can in particular be formed to achieve a particle size distribution, which is suitable for the activation, wherein a generation or avoidance of superfines is provided, depending on the type of the substance and/or substance mixture to be activated. The activation zone Z3 can furthermore be formed to achieve a largest possible activation via a control of a dwell time in the activation zone Z3 and a strain type and strain intensity in the activation zone Z3. The discharge zone or outlet zone Z5, respectively, can have a separating system 18 for retaining the activation bodies K and avoidance of reaction processes of the activated substance and/or substance mixture.

The plurality of devices 1 preferably have the same features, that is, they can be formed similarly. However, the disclosure herein is not limited to similarly formed devices 1 on the agitator shaft 12 but individual properties of the devices 1 can deviate from one another and can in particular be adapted to requirements in the respective activation zones Z1, Z2, Z3, Z4, Z5.

FIG. 2 shows a schematic detail view of a cutout of an agitator shaft 12 of an agitator system 10 according to a further example embodiment of the disclosure herein with a plurality of impact units 3, which are arranged offset from one another. The agitator shaft 12 can be integrated, for example, into the agitator system 10 according to FIG. 1.

For example, a plurality of devices 1 for the mechanical activation of organic and/or inorganic substances and/or substance mixtures in chemical, pharmaceutical, food-related and/or building material-related applications are mounted on the agitator shaft 12, of which devices eight are illustrated in the cutout. Here, each device 1 comprises a disk-like agitating body 2 and four impact units 3. The four impact units 3 each have an extension arm 7 and a head region 4 with an activation surface 5 for cooperating with activation bodies K. The four impact units 3 are fastened to the disk-like agitating body 2 radially on the outside with respect to an axis of rotation of the disk-like agitating body 2.

The head region 4 can have an essentially cube-like shape, as it is illustrated in FIG. 2. The extension arm 7 can be arranged, for example, between the disk-like agitating body 2 and the activation surface 5. A first end region of the extension arm 7 can be fastened to the disk-like agitating body 2 thereby and a second end region facing away from the first end region can be coupled to the activation surface 5.

A spacer sleeve 17 is furthermore in each case arranged in an example manner between adjacent devices 1 here. The spacer sleeve 17 can vary in diameter and in shape. The spacer sleeve 17 serves in particular for a targeted guidance of the air and of the substance and/or substance mixture to be activated through the container 11.

Here, the activation surface 5 is aligned, for example, in an angular range 8 of approximately 0° to approximately 45° with respect to the axis of rotation X. In an example manner, the activation surface 5 is formed in an essentially flat manner.

A distance d1 between two devices 1 can be, for example, between 10 times and 30 times or between 4 and 100 times a diameter of the activation bodies K. The distance d1 between two head regions 4 can in particular be dimensioned by impact units 3, which are arranged so as to be aligned with one another, as it is illustrated in an example manner in FIG. 2.

For example, the agitator shaft 12 can be formed in one piece or in multiple pieces. Alternatively or additionally, the agitator shaft 12 can be formed as massive shaft or as hollow shaft.

On the basis of a predetermined combination of different structural activation parameters and of different process-related activation parameters, the substance and/or the substance mixture to be activated can be guided through the activation zones Z1, Z2, Z3, Z4, Z5. An optimal mechanochemical reaction process can thus be provided. The structural activation parameters comprise, for example, different geometric embodiments of the disk-like agitating body 2, of the extension arm 7 and/or of the head region 4 of the impact unit 3. The process-related activation parameters comprise, for example, a circumferential speed, a fill level of the activation bodies, a temperature in the container 11 and/or flow-through of the container with a process gas, which is required for the mechanochemical reaction.

FIG. 3 shows a schematic side view of a device 1 for the mechanical activation of organic and/or inorganic substances and/or substance mixtures in chemical, pharmaceutical, food-related and/or building material-related applications according to a further example embodiment of the disclosure herein. The embodiment according to FIG. 3 can be referred to as a closed embodiment of the device 1.

For example, the device 1 comprises a disk-like agitating body 2 for the rotationally fixed mounting on an agitator shaft 12 here as well as at least one impact unit 3, which has a head region 4 with an activation surface 5 for cooperation with activation bodies. The at least one impact unit 3 is fastened to the disk-like agitating body 2 radially on the outside with respect to an axis of rotation X of the disk-like agitating body 2. The at least one impact unit 3 can in particular protrude radially or in the radial direction, respectively, from the disk-like agitating body 2 with respect to the axis of rotation X.

For example, the at least one impact unit 3 can have a plurality of impact units 3, for example eight here, which are arranged so as to be distributed evenly in a circumferential direction U of the disk-like agitating body 2. The substance and/or the substance mixture can be activated essentially evenly by the plurality of impact units 3 in this way when the disk-like agitating body 2 rotates.

The plurality of impact units 3 can be selected as a function of an angle 9 between two adjacent impact units 3, of a diameter of the disk-like agitating body 2, of a rotational speed of the disk-like agitating body 2 and of a diameter of the activation bodies K. The number of impact units 3 can thus be selected as needed at the disk-like agitating body 2. The angle 9 between two adjacent impact units 3 can be, for example, approximately 10° to approximately 180°, in particular approximately 10° to approximately 120°.

The head region 4 can optionally be connected to the impact unit 3 in an exchangeable manner. The head region 4 can be changed as needed in this way, for example when the activation surface 5 is worn out or when, for example, a different size and/or shape of the activation surface 5 is provided for the substance and/or substance mixture to be activated. The head region 4 can thus be formed in a modular manner. Advantageously, a surface load of the activation surface 5 can thus be improved or a width of the head region 4 can be changed as a function of a hardness of the substance and/or substance mixture to be activated.

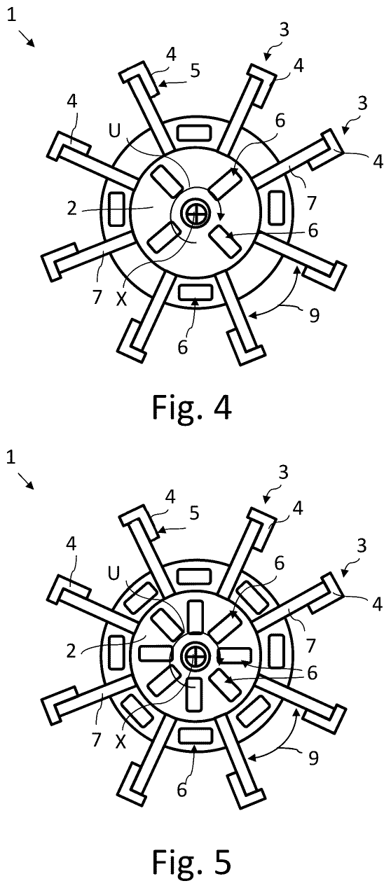

FIG. 4 shows a schematic side view of the device 1 from FIG. 3 according to a further example embodiment of the disclosure herein with a plurality of passage openings in the agitating body. The embodiment according to FIG. 4 can be referred to as a partially open embodiment of the device 1.

For example, the disk-like agitating body 2 has at least one passage opening 6, which extends in the direction of the axis of rotation. A size of the at least one passage opening 6 can furthermore be variable, so that a permeability of the disk-like agitating body 2 can be varied. An air quantity, which flows through, and a substance and/or substance mixture to be activated can be forced in this way to flow around the disk-like agitating body 2. The at least one passage opening 6 can have, for example, a round or a polygonal, for example square, cross section.

The at least one passage opening 6 can in particular have a plurality of passage openings 6, for example eight passage openings, which are arranged so as to be distributed evenly in a circumferential direction U of the disk-like agitating body 2. The substance and/or the substance mixture can thus pass or flow through, respectively, the disk-like agitating body 2, without coming into contact with the at least one impact unit 3.

A spacer sleeve 17, as it is described, for example, in FIG. 2, can optionally have a passage opening, which corresponds to the passage opening 6 of the disk-like agitating body 2, so that the passage opening of the spacer sleeve 17 and the passage opening 6 of the disk-like agitating body 2 can form a common passage opening 6. In other words, the passage opening of the spacer sleeve 17 and the passage opening 6 of the disk-like agitating body 2 can be arranged so as to be aligned. An air guidance and thus a control of a flow direction and of a flow speed can thus be influenced.

FIG. 5 shows a schematic side view of the device 1 from FIGS. 3 and 4 according to a further example embodiment of the disclosure herein with a plurality of passage openings in the agitating body. The embodiment according to FIG. 5 can be referred to as an open embodiment of the device 1.

In contrast to FIG. 4, the device 1 has, for example, sixteen passage openings 6 here, which are arranged so as to be distributed evenly in a circumferential direction U of the disk-like agitating body 2. For example, the passage openings 6 are in particular arranged in the shape of several rings, for example two rings, as illustrated in FIG. 5.

Different features for improving the stringency of the illustration have been combined in one or several examples in the preceding detailed description. It should be clear thereby, however, that the above description is only of an illustrative, but in no way of a limiting nature. It serves to cover all alternatives, modifications and equivalents of the different features and example embodiments. Many other examples will be immediately and directly clear to the person of skill in the art based on his/her technical knowledge in consideration of the above description.

The example embodiments were selected and described in order to be able to represent the principles, on which the invention is based, and its application possibilities in practice in the best possible way. Experts can thus optimally modify and use the invention and its different example embodiments with regard to the intended use. The terms “including” and “having” are used as neutral terminologies for the corresponding terms “comprising” in the claims as well as the description. A use of the terms “a”, “an”, “one” is to furthermore not generally rule out a plurality of features and components, which are described in this way.

### LIST OF REFERENCE NUMERALS

1 device
2 disk-like agitating body
3 impact unit
4 head region
5 activation surface
6 passage opening
7 extension arm
8 angular range of the activation surface
9 angle between two adjacent impact units
10 agitator system
11 container
12 agitator shaft
13 temperature-control unit
14 motor
15 inlet opening
16 outlet opening
17 spacer sleeve
18 separating system
19 pre-crushing element
20 additional opening
d1 distance between two devices
K activation bodies
X axis of rotation
U circumferential direction
Z1 inlet zone
Z2 comminution zone
Z3 activation zone
Z4 relaxation zone
Z5 discharge zone

1. A device for mechanical activation of organic and/or inorganic substances and/or substance mixtures in chemical, pharmaceutical, food-related and/or building material-related applications, the device comprising:
a disk-like agitating body for rotationally fixed mounting on an agitator shaft; and
at least one impact unit, which has a head region with an activation surface for cooperation with activation bodies, wherein the at least one impact unit is fastened to the disk-like agitating body radially on an outside with respect to an axis of rotation of the disk-like agitating body.

2. The device according to claim 1, wherein the at least one impact unit has a plurality of impact units, which are arranged so as to be distributed evenly in a circumferential direction of the disk-like agitating body.

3. The device according to claim 2, wherein the plurality of impact units is selected as a function of an angle between two adjacent impact units, of a diameter of the disk-like agitating body, of a rotational speed of the disk-like agitating body and of a diameter of the activation bodies.

4. The device according to claim 1, wherein the disk-like agitating body has at least one passage opening, which extends in a direction of the axis of rotation.

5. The device according to claim 4, wherein the at least one passage opening has a plurality of passage openings, which are arranged so as to be distributed evenly in a circumferential direction of the disk-like agitating body.

6. The device according to claim 1, the activation surface is aligned in an angular range of approximately 0° to approximately 45° with respect to the axis of rotation.

7. The device according to claim 1, wherein the head region is connected to the impact unit in an exchangeable manner.

8. The device according to claim 1, wherein the head region has an essentially cube-like shape.

9. The device according to claim 1, wherein the at least one impact unit has an extension arm, which is arranged between the disk-like agitating body and the activation surface.

10. An agitator system for mechanical activation of organic and/or inorganic substances and/or substance mixtures in chemical, pharmaceutical, food-related and/or building material-related applications, the agitator system comprising:
a container for receiving activation bodies as well as a substance and/or substance mixture to be activated;
an agitator shaft, which is mounted in the container and so as to be rotatable with respect to the container; and
at least one device according to claim 1, wherein the disk-like agitating body is mounted in a rotationally fixed manner on the agitator shaft.

11. The agitator system according to claim 10, wherein a radially outer end of the at least one impact unit has a distance from the container in a range of twice to ten times a diameter of the activation bodies.

12. The agitator system according to claim 10, wherein the at least one device has a plurality of devices, which are arranged in series on the agitator shaft.

13. The agitator system according to claim 12, wherein the at least one impact unit of adjacent devices of the plurality of devices are in each case arranged on the agitator shaft with an offset of 5° to 90° from one another.

14. The agitator system according to claim 10, wherein the container has a plurality of activation zones, which differ from one another and which are arranged successively along a flow-through direction of the substance and/or substance mixture to be activated.

15. The agitator system according to claim 14, wherein the plurality of activation zones, which differ from one another, comprises at least one activation zone selected from a group of an inlet zone for improved intake of the substance and/or substance mixture to be activated, a comminution zone for providing a particle size distribution suitable for the activation, an activation zone for creation of a largest possible activation, a relaxation zone and a discharge zone for retaining the activation bodies and avoiding reaction processes of the activated substance and/or substance mixture.

16. The agitator system according to claim 10, wherein the activation bodies are formed essentially spherically, wherein a sphere-equivalent diameter of the activation bodies lies in a range of approximately 1 mm to approximately 15 mm.

17. The agitator system according to claim 10, wherein the container has a double jacket for insulation of its interior space with respect to a surrounding area.

18. The agitator system according to claim 10, wherein the agitator shaft is motor-driven.

19. The agitator system according to claim 10, further comprising an inlet opening and an outlet opening, wherein the inlet opening and the outlet opening are arranged on opposite sides of the container.

20. The agitator system according to claim 10, further comprising a spacer sleeve, which is mounted between adjacent devices on the agitator shaft.
